(19) United States
(12) Patent Application Publication
(10) Pub. No.: US 2017/0209925 A1
(43) Pub. Date: Jul. 27, 2017

(54) A Method Of Making A Capacitor Grade Powder And Capacitor Grade Powder From Said Process

(71) Applicant: Global Advanced Metals USA, Inc., Waltham, MA (US)

(72) Inventors: Eiji Kataoka, Fukushima (JP); Shuhei Yoshikawa, Fukushima (JP); John Koenitzer, Waltham, MA (US)

(73) Assignee: Global Advanced Metals USA, Inc., Waltham, MA (US)

(21) Appl. No.: 15/328,501

(22) PCT Filed: Aug. 12, 2014
(86) PCT No.: PCT/US14/50609

§ 371 Date: Jan. 24, 2017

(51) Int. Cl. B22F 1/00; H01G 9/042; C22C 27/02; B22F 9/04; B22F 9/08

(52) U.S. Cl. CPC B22F 1/0096; B22F 9/04; B22F 9/08; C22C 27/02; H01G 9/042

(57) ABSTRACT

The present invention related to a method to make capacitor grade powder. The method includes the use of a spray dryer that includes a rotating atomizer disk to form agglomerated powder and the method further includes a heat treatment step. Capacitor grade powder formed by the methods of the present invention are further described.

### BACKGROUND OF THE INVENTION

The present invention relates to capacitor grade powders and methods of making the same. More specifically, the present invention relates to a method of making a capacitor grade powder using at least one spray dryer. The present invention further relates to products resulting from the methods of the present invention, including capacitor grade powders having one or more desirable properties, such as high Scott density.

Among its many applications, valve metal powder, such as tantalum powder, is generally used to produce capacitor electrodes. Tantalum capacitor electrodes, in particular, have been a major contributor to the miniaturization of electronic circuits. Such capacitor electrodes typically are manufactured by compressing agglomerated tantalum powder to less than half of the metal's true density with an electrode lead wire to form a pellet, sintering the pellet in a furnace to form a porous body (i.e., an electrode), and then subjecting the porous body to anodization in a suitable electrolyte to form a continuous dielectric oxide film on the sintered body. The anodized porous body can then be impregnated with a cathode material, connected to a cathode lead wire, and encapsulated. As is known to those skilled in the art, valve metals generally include tantalum, niobium, and alloys thereof, and also may be metals of Groups IVB, VB, and VIB and alloys thereof. Valve metals are described, for example, by Diggle, in “Oxides and Oxide Films,” Vol. 1, pages 94-95, 1972, Marcel Dekker, Inc., New York.

In attempts to achieve a tantalum metal powder having the desirable characteristics for making capacitor electrodes and similar products, powders were limited by the processes by which they were produced. Currently, for example, tantalum powders are generally produced via one of two methods: a mechanical process or a chemical process. The mechanical process includes the steps of electron beam melting of tantalum to form an ingot, hydriding the ingot, milling the hydride, and then dehydriding, crushing, and heat treating. This process generally produces powder with high purity, which is used in capacitor applications where high voltage or high reliability is required. The mechanical process suffers, however, from high production costs. In addition, tantalum powders produced by the mechanical process generally have low surface area.

The other generally utilized process for producing tantalum powder is a chemical process. Several chemical methods for producing tantalum powders suitable for use in capacitors are known in the art. U.S. Pat. No. 4,067,736, issued to Vartanian, and U.S. Pat. No. 4,149,876, issued to Rerat, relate to the chemical production process involving sodium reduction of potassium fluorotantalate (K₂TaF₇). A review of typical techniques is also described in the background sections of U.S. Pat. No. 4,684,399, issued to Bergman et al., and U.S. Pat. No. 5,234,491, issued to Chang. All patents are incorporated in their entirety by reference herein.

Tantalum powders produced by chemical methods, for example, are well-suited for use in capacitors because they generally have larger surface areas than powders produced by mechanical methods. The chemical methods generally involve the chemical reduction of a tantalum compound with a reducing agent. Typical reducing agents include hydrogen and active metals such as sodium, potassium, magnesium, and calcium. Typical tantalum compounds include, but are not limited to, potassium fluorotantalate (K₂TaF₇), sodium fluorotantalate (Na₂TaF₇), tantalum pentachloride (TaCl₅), tantalum pentafluoride (TaF₅), and mixtures thereof. The most prevalent chemical process is the reduction of K₂TaF₇ with liquid sodium.

In the chemical reduction of a valve metal powder, such as tantalum powder, potassium fluorotantalate is recovered, melted, and reduced to tantalum metal powder by sodium reduction. Dried tantalum powder can then be recovered, thermally agglomerated under vacuum to avoid oxidation of the tantalum, and crushed. As the oxygen concentration of the valve metal material can be important in the production of capacitors, the granular powder typically is then deoxidized at elevated temperatures (e.g., up to about 1000° C. or higher) in the presence of a getter material, such as an alkaline earth metal (e.g., magnesium), that has a higher affinity for oxygen than the valve metal. However, alkaline earth metals can form refractory oxides that are undesired for use of the powders in producing capacitors. A post-deoxidation process acid leaching conducted under normal atmospheric conditions (e.g., approximately 760 mm Hg) has been performed using a mineral acid solution including, for example, sulfuric acid or nitric acid, to dissolve metal and refractory oxide contaminants (e.g., magnesium and magnesium oxide contaminants) before the material is further processed to produce capacitors. The acid leached powders are washed and dried, and may then be compressed, sintered, and anodized in conventional manners to make sintered porous bodies, such as anodes for capacitors.

The resultant surface area of a finished tantalum powder is an important factor in the production of capacitors. The charge capability (CV) of a tantalum (for example) capacitor (typically measured as microfarad-volts) typically is directly related to the total surface area of the anode after sintering and anodization. Capacitors having high surface area anodes have been desirable because the greater the surface area, the greater the charge capacity of the capacitor. Another parameter attracting attention in tantalum powder production has been with respect to control of oxygen content during powder processing. During the later processing of these powders into anodes for capacitors, the dissolved oxygen may recrystallize as an oxide and contribute to voltage breakdown or high current leakage of the capacitor by shorting through the dielectric layer of amorphous oxide. Also, the purity of the powder is a consideration in its use in capacitor production as metallic and non-metallic contamination may degrade the dielectric oxide film on the capacitors.

In order to address the miniaturization of capacitors that has occurred in recent years, there is a need for particles with a small particle size for use as agglomerated tantalum particles in capacitors. As far as primary tantalum particles are concerned, particles with a small particle size are preferred because they can increase the surface area of the tantalum pellet and can raise the electrical capacitance of the capacitor.

In addition, the tantalum preferably has a narrow particle size distribution because this can increase the diameter of the voids in the tantalum pellet and improve the fill properties of the solid electrolyte.

Furthermore, the tantalum is preferably particles with a low bulk density because they afford a high rate of compression during tantalum pellet molding and facilitate molding in predetermined shapes. However, such low-bulk-density tantalum having a small particle size and a narrow particle size distribution are not obtained by previous manufacturing processes on a consistent basis or at all.

Accordingly, there is a need in the industry to create methods to address one or more of the above-identified disadvantages of current methods to make valve metal powders, such as tantalum powder.

### SUMMARY OF THE PRESENT INVENTION

A feature of the present invention is to provide a method to make capacitor grade powder that use a spray dryer during the manufacturing process.

An additional feature of the present invention is to provide capacitor grade powder that can be made through use of a spray dryer and yet achieve desirable powder properties, such as acceptable Scott densities and the like.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention, in part, relates to a method of making a capacitor grade powder or a capacitor grade metal powder. The method includes feeding a slurry of powder (e.g., metal powder or capacitor grade metal powder) into a spray dryer that includes a rotating atomizer disk and forming dried agglomerated powder. The method further includes heat treating the dried agglomerated powder to form a capacitor grade powder, wherein the powder is tantalum, niobium, or a niobium suboxide.

The present invention further relates to the capacitor grade powder resulting from the method(s) of the present invention.

The present invention further relates to capacitor grade powder, such as tantalum powder, having desirable Scott densities and/or other capacitor grade powder properties, such as high capacitance, a narrow particle size distribution, and/or good flowability, and the like.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

It is to be understood that both the foregoing general description and the following detailed description are exemplary and explanatory only and are intended to provide a further explanation of the present invention, as claimed.

### BRIEF DESCRIPTION OF THE DRAWINGS

FIG. 1 is a drawing that provides the basic parts (in a simplified view) of a spray dryer.

FIG. 2 is a graph plotting the particle diameter versus frequency (% by number of particles) for Examples 10, 11, and 14 of the present invention.

FIG. 3 is a graph plotting the particle diameter versus frequency (% by number of particles) for Examples 6 and 7 of the present invention.

FIG. 4 is a graph plotting the particle diameter versus frequency (% by number of particles) for Examples 8 and 9 of the present invention.

FIG. 5 is a graph plotting the particle diameter versus frequency (percent by number of particles) for Examples 18 and 19 of the present invention and comparative Example 22.

FIG. 6 is a graph plotting the particle diameter versus frequency (percent by number of particles) for Examples 20 and 21 of the present invention and comparative Example 23.

### DETAILED DESCRIPTION OF THE PRESENT INVENTION

The present invention relates to methods to form capacitor grade powder. The methods particularly involve the use of at least a spray dryer or a spray dryer step. The present invention further relates to products resulting from the methods of the present invention.

In more detail, the present invention relates to methods of making a capacitor grade powder that includes feeding a slurry of powder (e.g., water slurry) into a spray dryer that includes a rotating atomizer disk and forming agglomerated powder (e.g., dried agglomerated powder). The method further includes heat treating the agglomerated powder to form capacitor grade powder. The capacitor grade powder is preferably tantalum metal, niobium metal, or a niobium suboxide, or any combination thereof.

With regard to the powder that is used to form the slurry, any capacitor grade powder and/or metal powder and/or metal oxide powder that is capable of being formed into a capacitor anode can be used. Specific examples include, but are not limited to, valve metal powders, or conductive oxides thereof. More specific examples include, but are not limited to, tantalum metal powder, niobium metal, and/or niobium suboxide powders. The niobium suboxide powder can be of the formula NbOₓ, wherein x is 0.7 to 1.2. More specific examples are where x is 0.8 to 1. Examples include NbO, NbO_{1.1}, NbO_{0.8}, NbO_{0.9}, and the like. The niobium suboxide powders and, in general, acceptable niobium suboxide powders are those that are conductive.

It is to be understood that there is no critical limitations with regard to the type of tantalum powder, niobium powder, or niobium suboxide powder that can be used in the methods of the present invention for purposes of forming the agglomerated powder. As mentioned above, the tantalum powder can be what is considered sodium reduced tantalum powder, or it can be vapor phased-reduced tantalum.

The powder that is preferably used to form a slurry can be what is considered basic lot powder, such as basic lot tantalum, basic lot niobium, and/or basic lot niobium suboxide(s). The powder that can be used to form the slurry can be what is considered secondary particles of capacitor grade powders, such as tantalum, niobium, or niobium suboxide.

Secondary particles of tantalum can be obtained by a melt reduction of potassium fluorotantalate (K₂TaF₇) (also referred to as “melt-reduced secondary particles of tantalum”) or secondary particles of tantalum can be obtained by a sodium reduction of tantalum in the vapor phase (also referred to as “vapor phase-reduced secondary particles of tantalum”). Thus, these secondary particles of tantalum can be produced by tantalum salt reduction.

Melt-reduced secondary particles of tantalum can be obtained in a process involving reducing potassium fluorotantalate (K₂TaF₇) with sodium in molten salt to produce secondary particles that are agglomerates of primary particles and then optionally water-washing, acid-washing, and drying these secondary particles.

Vapor phase-reduced secondary particles of tantalum can be obtained by contacting and reacting vaporized tantalum chloride with vaporized sodium. These vapor phase-reduced secondary particles of tantalum are composed of multiple primary particles of tantalum formed by the reaction between tantalum chloride and sodium that are encased in the sodium chloride produced by this reaction.

In general, the volume-mean particle size of the primary particles of tantalum can be from 20-30 nm.

With regard to the slurry, the slurry can be an aqueous slurry or aqueous-based slurry, such as a water slurry. Put another way, the slurry can be formed by combining or mixing together the metal powder with water in appropriate amounts to form the slurry.

For instance, the slurry can comprise from about 35 wt % to about 70 wt % tantalum powder, based on the total weight of the slurry. This amount can be more preferably from about 40 wt % to about 60 wt %, or from about 45 wt % to about 55 wt % tantalum powder, based on the total weight of the slurry.

When the powder is niobium powder or a niobium suboxide powder, the amount of powder in the slurry can be from about 20 wt % to about 50 wt %, or from about 25 wt % to about 45 wt %, or from about 30 wt % to about 50 wt % metal powder, based on the total weight of the slurry.

As an option, the powder that is formed into a slurry can be phosphorous doped. For instance, the phosphorous doped levels can be at least 50 ppm, or at least 100 ppm, or, for instance, from about 50 ppm to about 500 ppm, and the like. Phosphoric acid or ammonium hexafluorophosphate and the like are suggested as the forms of phosphorus. If the amount of the secondary particles of tantalum used is 100 wt %, the amount of the added phosphorus or boron is preferably 0.01-0.03 wt % (100-300 ppm).

The powder that is used to form the slurry can, prior to this step, be an acid washed powder to remove impurities. Further, the powder, prior to being formed into a slurry, can be a vacuum dried powder, or it can be an acid washed and vacuumed dried powder.

As an option, prior to forming into a slurry, the powder can be crushed or pulverized to reduce particle size and/or to obtain a more consistent particle size distribution. The crushing can involve feeding the powder through a chopper mill or pulverizer or granulator. One example is a granulator, such as a Spartan granulator.

The particle size of the secondary particles can be adjusted in the process of pulverizing. If the pulverizing process is more intense or if pulverization is conducted for a longer time, the particle size becomes smaller.

The crushing or pulverizing can be done with an apparatus equipped with one or more low-speed impellers used for stirring particles and one or more high-speed impellers rotating at a rotational speed that is at least 10 times higher than that of the low-speed impellers. From a practical point of view, the rotational speed of the high-speed impellers is preferably at least 30 times higher, and even more preferably, at least 100 times higher than the rotational speed of the low-speed impellers. In addition, it is preferably not more than 1,000 times higher than the rotational speed of the low-speed impellers. Specifically, it can be set to approximately 6,000 rpm.

One example is a Spartan granulator (e.g., model RMO-4H) from Fuji Paudal Co., Ltd., which is equipped with a cylindrical vessel, a low-speed impeller that rotates along the interior peripheral walls of the vessel, a high-speed impeller that rotates at a rotational speed higher than that of the low-speed impeller at the center of the vessel, and a sprayer that sprays water inside the vessel. The rotational speed of the low-speed impeller can be 13-27 rpm. If the rotational speed of the low-speed impeller is 13 rpm or higher, such a rotational speed will be sufficient for supplying the particles being crushed (pulverized) to the high-speed impeller while stirring them, and a speed of not more than 27 rpm can prevent unnecessary stirring of the particles that undergo crushing (pulverization). The rotational speed of the high-speed impeller can be 750-6,200 rpm. If the rotational speed of the high-speed impeller is 750 rpm or higher, the particles can be pulverized to a sufficient degree. However, there is no advantage to increasing the rotational speed beyond 6,200 rpm because this does not change the degree of pulverization.

Another example of a device for this granulating or pulverizing is a “High Flex Gral” from Fukae Powtec Co., Ltd., which can have a low-speed impeller and equipped with multiple stirrer blades attached to a rotary shaft arranged in the diametrical direction of the vessel. The high-speed impeller can be adapted to rotate at a rotational speed that is higher than that of the low-speed impeller.

Furthermore, another example is a “Loedige Mixer” from Matsubo Corporation, that can include a cylindrical vessel; a low-speed impeller rotating along the interior peripheral walls about the central axis of the vessel as a center of rotation; a high-speed impeller installed on the peripheral wall of the vessel facing the central axis of the vessel. The rotational speed of the low-speed impeller can be 100-300 rpm. If the rotational speed of the low-speed impeller is 100 rpm or higher, such a rotational speed will be sufficient for supplying the secondary particles being crushed (pulverized) to the high-speed impeller while stirring them, and a speed of not more than 300 rpm can prevent unnecessary stirring of the particles undergoing crushing (pulverization). The rotational speed of the high-speed impeller can be 1,500-6,000 rpm. If the rotational speed of the high-speed impeller is 1,500 rpm or higher, the particles can be pulverized to a sufficient degree. However, there is no advantage to increasing the rotational speed beyond 6,000 rpm because this does not change the degree of pulverization.

The pulverizing apparatus can be any apparatus possessing a pulverizing capability. Ball mills, chopper mills, speed mills, cutter mills, screen mills, jet mills, etc., are examples of pulverizing machines. The pulverizing apparatus can optionally be used to also form the slurry by feeding wet feedstock (Ta or Nb or NbO) or adding water during the pulverizing.

With regard to the crushing or pulverizing step, this preferably reduces the particle size from more than 5 microns for the D₅₀ to less than about 2.5 microns for the D₅₀, for instance, measured by a Microtrac. Microtrac is particle size analyzer using laser diffraction technology. The sample is introduced into the circulation filled water. When the laser hits the sample, particle size is measured by the degree of diffraction different depending on the particle size.

With regard to the spray dryer, a spray dryer that includes a rotating atomizer disk is used and which leads to the formation of dry agglomerated powder. The operating conditions that are preferably used for the spray dryer and rotating atomizer disk are as follows.

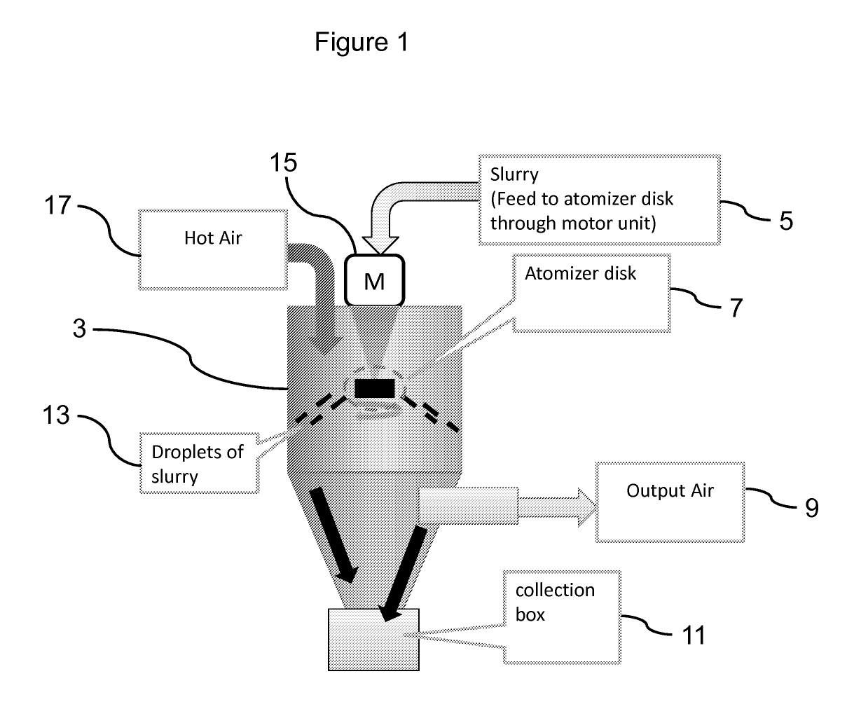

A simplified view is shown in FIG. 1. In FIG. 1, the sprayer dryer (3) has slurry (5) introduced through an inlet or motor unit (15). Hot air (17) is fed into the spray dryer. The sprayer dryer has a rotating atomizer disk (7) wherein as a result, droplets of slurry (13) are formed and eventually recovered in a collection box (11). The heated air is exits to an outlet or output air (9).

The rotating atomizer disk can rotate, for instance, at an rpm rate of 5,000 rpm or higher, such as 10,000 rpm or higher, or from about 10,000 rpm to about 50,000 rpm, or the like. As a further example, the rotating atomizer disk can rotate at a rate of from about 15,000 rpm to about 40,000 rpm.

While the rotating atomizer disk can have a variety of different diameters, preferably, the diameter of the rotating atomizer disk is at least 20 mm, such as from about 20 mm to about 200 mm, or from about 35 mm to about 150 mm, or from about 50 mm to about 125 mm, and the like.

The rotating atomizer disk can additionally or alternatively be characterized by the circumferential speed of the disk, which is a combination of disk size and rpm rate. The powder size and PSD can be influenced by the circumferential speed. The circumferential speed is in meter/sec or m/s. For instance, if the diameter of the disk is 10 mm and the rpm rate is 10,000 rpm, the circumferential speed is 5.2 m/s (calculated: atomizer disk 10 mmφ and 10000 rpm=10 (mm)×3.14×10000 (rpm)/1000/60=5.2 m/s). The circumferential speed of the disk can be 20 m/s or greater, 30 m/s or greater, 40 m/s or greater, 50 m/s or greater, such as from about 20 m/s to about 125 m/s, from about 25 m/s to about 100 m/s, from about 30 m/s to about 100 m/s, from about 35 m/s to about 95 m/s, from about 40 m/s to about 75 m/s, or from about 40 m/s to about 60 m/s.

The spray dryer has an inlet temperature and this inlet temperature, for purposes of the present invention, is preferably at least 100° C., for instance, from about 100° C. to about 200° C., from about 120° C. to about 170° C., from about 130° C. to about 150° C., and the like.

The spray dryer also has an outlet temperature. For purposes of the present invention, the outlet temperature is lower by at least 10° C. than the inlet temperature, is lower by at least 20° C. than the inlet temperature, is lower by least 30° C. than the inlet temperature, is lower by at least 50° C. than the inlet temperature, and the like. For instance, the outlet temperature can be lower by from about 10° C. to about 100° C. than the inlet temperature. The outlet temperature can be lower by from about 50° C. to about 100° C. than the inlet temperature. For instance, the outlet temperature can be from about 50° C. to about 190° C., or from about 75° C. to about 190° C., or from about 100° C. to about 175° C., and the like.

The slurry can be fed into the spray dryer at a variety of feed rates. For instance, the feed rate can be at least 0.5 kg/hour, or at least 1 kg/hour, or at least 2 kg/hour, or from about 0.5 kg/hour to about 5 kg/hour or more, or from about 1 kg/hour to about 4 kg/hour, and the like.

Examples of suitable spray dryers that are commercially available can be obtained from Ohkawara Kakohki of Japan or Preci and, for instance, Model Nos. CL-8I, CL-12, and TR160 can be used.

After exiting the spray dryer, as an option, the method of the present invention can further include drying or further drying the dried agglomerated powder to further reduce any moisture content. For instance, this additional drying after exiting the spray dryer can be at a temperature of at least 50° C. for 10 minutes or more, such as for at least 1 hour or more, or for at least 3 hours or more. The drying temperature can be at least 50° C., at least 70° C., or, for instance, from about 50° C. to about 100° C., or from about 50° C. to about 150° C., and the like. The purpose of this optional drying step is to further remove any excess moisture prior to the heat treating step. In general, if the moisture content of the dried agglomerated powder exiting the spray dryer is less than 0.5 wt %, based on the weight of the powder, no further drying step is used. If the moisture content of the powder is 0.5 wt % or greater, then further drying can occur, though this step is optional. In any case, if desired, one or more drying steps can be optionally used, irrespective of the moisture content amount.

With regard to the heat treating step of the dried agglomerated powder, the heat treating can occur in a conventional oven under vacuum or under inert temperature. The heat treatment temperature is generally at least 800° C., or at least 1,000° C., or from about 800° C. to about 1,450° C., or from about 1,000° C. to about 1,450° C., and the like. While any heat treatment time can be used, examples include, but are not limited to, at least 10 minutes, at least 30 minutes, from about 10 minutes to about 2 hours, or more.

As an option, one or more heat treatments can occur, whether at the same temperature, same times, or at different temperatures and/or different heat treatment times.

With regard to the heat treatment step, it is to be understood that this heat treatment step is a form of sintering. However, it is to be understood that the capacitor grade powder still has flowability after this heat treatment step or, with mild pulverizing or milling, a flowable agglomerated powder can be formed. This sintering step does not lead to a mass of consolidated metal powder that cannot be broken apart. This heat treatment step can permit degassing of impurities like hydrogen and alkali metals, that for instance, come from the raw material and agents used in any reduction step in the processing step of making capacitor grade powder. The heat treatment step can control physical properties like Scott number (Scott density) and agglomerate powder strength by adjusting one or more processing conditions.

The method can optionally further include subjecting the capacitor grade powder after heat treating to at least one deoxidation or ‘deox’ step. The deoxidation can involve subjecting the capacitor grade powder to a temperature of from about 500° C. to about 1,000° C. in the presence of at least one oxygen getter. For instance, the oxygen getter can be a magnesium metal or compound. The magnesium metal can be in the form of plates, pellets, or powder. Other oxygen getter material can be used.

In more detail, in the deoxidation step, a reducing agent such as magnesium and the like is added to the heat treated particles and the particles are heated at a temperature above the melting point and below the boiling point of the reducing agent in an inert gas atmosphere, such as argon or in a vacuum. The deoxidation treatment may be conducted once or multiple times.

The deoxidized powder can also be subjected to acid leaching, such as using conventional techniques or other suitable methods. The various processes described in U.S. Pat. Nos. 6,312,642 and 5,993,513, for example, can be used herein and are incorporated in their entireties by references herein. The deoxidized valve metal powder can be acid leached to remove soluble contaminants, such as acid soluble magnesium oxides and other magnesium oxide contaminants. The acid leaching can be performed using an aqueous acid solution comprising a strong mineral acid as the predominant acid, for example, nitric acid, sulfuric acid, hydrochloric acid, and the like. Also, a hydrofluoric acid (e.g., HF) in minor amounts (e.g., less than 10% by weight, or less than 5% by weight, or less than 1% by weight based on the total weight of acid) can be used. The mineral acid concentration (e.g., HNO₃ concentration) can range from about 20% by weight to about 75% by weight in the acid solution. The acid leach can be conducted at elevated temperatures (above room temperature to about 100° C.) or at room temperature, using acid compositions and techniques as shown, for example, in U.S. Pat. No. 6,312,642 B1. The acid leach step typically is performed under normal atmospheric conditions (e.g., approximately 760 mm Hg). The acid leach step performed using conventional acid compositions and pressure conditions, such as indicated, can remove soluble metal oxides from the deoxidized powder for those conditions.

The mode diameter of the obtained agglomerated powder (e.g., tantalum) can be 15-80 μm.

The bulk density of the agglomerated powder can be 1-2.5 g/cm³.

As an option, the capacitor grade powder can be nitrogen doped. For instance, the nitrogen doping can be during the reduction step. With respect to nitrogen, the nitrogen can be in any state, such as a gas, liquid, or solid. The powders of the present invention, can have any amount of nitrogen present as a dopant or otherwise present. Nitrogen can be present as a crystalline form and/or solid solution form at any ratio.

Accomplishing the above non-optional steps makes it possible to obtain low-bulk-density reactor grade particles with a small particle size and a narrow particle size distribution.

The valve metal powder can be further processed to form a capacitor electrode (e.g., capacitor anode). This can be done, for example, by compressing the powder to form a body, sintering the body to form a porous body, and anodizing the porous body. The pressing of the heat-treated powder can be achieved by any conventional techniques such as placing the heat-treated powder in a mold and subjecting the powder to a compression by use of a press, for instance, to form a pressed body or green body. Various press densities can be used, and include, but are not limited to, from about 1.0 g/cm³ to about 7.5 g/cm³. The powder can be sintered, anodized, and/or impregnated with an electrolyte in any conventional manner. For instance, the sintering, anodizing, and impregnation techniques described in U.S. Pat. Nos. 6,870,727; 6,849,292; 6,813,140; 6,699,767; 6,643,121; 4,945,452; 6,896,782; 6,804,109; 5,837,121; 5,935,408; 6,072,694; 6,136,176; 6,162,345; and 6,191,013 can be used herein and these patents are incorporated in their entirety by reference herein. The sintered anode pellet can be, for example, deoxidized in a process similar to that described above for the powder. The anodized porous body further can be impregnated with manganese nitrate solution, and calcined to form a manganese oxide film thereon. Wet valve metal capacitors can use a liquid electrolyte as a cathode in conjunction with their casing. The application of the cathode plate can be provided by pyrolysis of manganese nitrate into manganese dioxide. The pellet can be, for example, dipped into an aqueous solution of manganese nitrate, and then baked in an oven at approximately 250° C. or other suitable temperatures to produce the manganese dioxide coat. This process can be repeated several times through varying specific gravities of nitrate to build up a thick coat over all internal and external surfaces of the pellet. The pellet optionally can be then dipped into graphite and silver to provide an enhanced connection to the manganese dioxide cathode plate. Electrical contact can be established, for example, by deposition of carbon onto the surface of the cathode. The carbon can then be coated with a conductive material to facilitate connection to an external cathode termination. From this point the packaging of the capacitor can be carried out in a conventional manner, and can include, for example, chip manufacture, resin encapsulation, molding, leads, and so forth.

As part of forming an anode, for example, a binder, such as camphor (C₁₀H₁₆O) and the like, can be added to the agglomerated powder, for instance, in the amount of 3-5 wt % based on 100 wt % of the agglomerated powder and the mixture can be charged into a form, compression-molded, and sintered by heating for 0.3-1 hour at 1,000-1,400° C. while still in a compressed state. Such a molding method makes it possible to obtain pellets consisting of sintered porous bodies.

When a pellet obtained using the above-described molding process is employed as a capacitor anode, before the agglomerated powder is compression-molded, it is preferable to embed lead wires into the agglomerated powder in order to integrate the lead wires into the pellet.

The capacitor can be manufactured using the above-described pellet. A capacitor equipped with an anode can be obtained by oxidizing the surface of the pellet, a cathode facing the anode, and a solid electrolyte layer disposed between the anode and cathode.

A cathode terminal is connected to the cathode by soldering and the like. In addition, an exterior resin shell is formed around a member composed of the anode, cathode, and solid electrolyte layer. Examples of materials used to form the cathode include graphite, silver, and the like. Examples of materials used to form the solid electrolyte layer include manganese dioxide, lead oxide, electrically conductive polymers, and the like.

When oxidizing the surface of a pellet, for example, a method can be used that involves treating the pellet for 1-3 hours in an electrolyte solution such as nitric acid, phosphoric acid and the like with a concentration of 0.1 wt % at a temperature of 30-90° C. by increasing the voltage to 20-60V at a current density of 40-120 mA/g. A dielectric oxide film is formed in the portion oxidized at such time.

As indicated, the powder of the present invention can be used to form a capacitor anode (e.g., wet anode or solid anode). The capacitor anode and capacitor (wet electrolytic capacitor, solid state capacitor, etc.) can be formed by any method and/or have one or more of the components/designs, for example, as described in U.S. Pat. Nos. 6,870,727; 6,813,140; 6,699,757; 7,190,571; 7,172,985; 6,804,109; 6,788,523; 6,527,937 B2; 6,462,934 B2; 6,420,043 B1; 6,375,704 B1; 6,338,816 B1; 6,322,912 B1; 6,616,623; 6,051,044; 5,580,367; 5,448,447; 5,412,533; 5,306,462; 5,245,514; 5,217,526; 5,211,741; 4,805,704; and 4,940,490, all of which are incorporated herein in their entireties by reference. The powder can be formed into a green body and sintered to form a sintered compact body, and the sintered compact body can be anodized using conventional techniques. It is believed that capacitor anodes made from the powder produced according to the present invention have improved electrical leakage characteristics. The capacitors of the present invention can be used in a variety of end uses such as automotive electronics; cellular phones; smart phones; computers, such as monitors, mother boards, and the like; consumer electronics including TVs and CRTs; printers/copiers; power supplies; modems; computer notebooks; and disk drives.

With the methods of the present invention, the capacitor grade powder can be made that can have a Scott density of at least 14 g/in³. For instance, the Scott density can be at least 20 g/in³, at least 25 g/in³, from about 20 g/in³ to about 40 g/in³, or from about 14 g/in³ to about 40 g/in³, and the like.

With the methods of the present invention, the capacitor grade powder can be made that can have:

a) a Scott Density of from about 14 g/in³ to about 35 g/in³,

b) a D10 particle size of from about 5 microns to about 25 microns,

c) a D50 particle size of from about 20 microns to about 50 microns,

d) a D90 particle size of from about 30 microns to about 100 microns, and/or

e) a BET surface area of from about 0.5 m²/g to about 20 m²/g.

or the capacitor grade powder can have at least one of the following properties:

a) a Scott Density of from about 20 g/in³ to about 35 g/in³,

b) a D10 particle size of from about 12 microns to about 25 microns,

c) a D50 particle size of from about 20 microns to about 40 microns,

d) a D90 particle size of from about 30 microns to about 70 microns, and/or

e) a BET surface area of from about 0.7 m²/g to about 15 m²/g.

For purposes of the present invention, at least one of these properties, at least two, at least three, at least four, or all five properties can be present.

With the present invention, the following conditions can be preferably used:

the slurry comprises from about 35 wt % to about 70 wt % capacitor grade powder, based on total weight of said slurry,

the slurry is an aqueous slurry,

the rotating atomizer disk rotates at from about 10,000 rpm to about 50,000 rpm,

the rotating atomizer disk has a diameter of from about 20 mm to about 200 mm,

the spray dryer has an inlet temperature of from about 100° C. to about 200° C.,

the spray dryer has an outlet temperature that is lower by at least 40° C. than an inlet temperature,

the slurry is fed into said spray dryer at a feed rate of at least 0.5 kg/hour, and

the heat treatment is at a temperature of at least 800° C.

With the present invention, a spray dryer can be used in the agglomeration step and yet achieve desirable Scott densities as mentioned above. In addition, the particle size distribution is quite tight and narrow. For instance, the particle distribution can be unimodal with an optional sharp peak. For instance, the particle diameter can be unimodal and the particle size can have a distribution of from about 10 to about 100 microns with the peak being at from about 30 microns to about 60 microns, or at from about 35 microns to about 55 microns, or at from about 40 microns to about 50 microns. The particle size distributions are measured by Mircrotrac.

The present invention includes the following aspects/embodiments/features in any order and/or in any combination:

1. A method of making a capacitor grade powder comprising

feeding a slurry of powder into a spray dryer that includes a rotating atomizer disk and forming dried agglomerated powder, and

heat treating said dried agglomerated powder to form said capacitor grade powder, wherein said powder is tantalum, niobium, or a niobium suboxide.

2. The method of any preceding or following embodiment/feature/aspect, wherein said powder is tantalum metal powder.
3. The method of any preceding or following embodiment/feature/aspect, wherein said powder is niobium metal powder.
4. The method of any preceding or following embodiment/feature/aspect, wherein said powder is niobium suboxide powder that is NbOₓ, where x is 0.7 to 1.2.
5. The method of any preceding or following embodiment/feature/aspect, wherein said powder is niobium suboxide that is NbOₓ, where x is 0.8 to 1.
6. The method of any preceding or following embodiment/feature/aspect, wherein said slurry comprises from about 35 wt % to about 70 wt % tantalum powder, based on total weight of said slurry.
7. The method of any preceding or following embodiment/feature/aspect, wherein said slurry is an aqueous slurry.
8. The method of any preceding or following embodiment/feature/aspect, wherein said slurry is a water slurry.
9. The method of any preceding or following embodiment/feature/aspect, wherein said slurry comprises from about 40 wt % to about 70 wt % tantalum powder, based on total weight of said slurry.
10. The method of any preceding or following embodiment/feature/aspect, wherein said slurry comprises from about 45 wt % to about 65 wt % tantalum powder, based on total weight of said slurry.
11. The method of any preceding or following embodiment/feature/aspect, wherein said rotating atomizer disk rotates at 5,000 rpm or higher.
12. The method of any preceding or following embodiment/feature/aspect, wherein said rotating atomizer disk rotates at 10,000 rpm or higher.
13. The method of any preceding or following embodiment/feature/aspect, wherein said rotating atomizer disk rotates at from about 10,000 rpm to about 50,000 rpm.
14. The method of any preceding or following embodiment/feature/aspect, wherein said rotating atomizer disk rotates at from about 15,000 rpm to about 40,000 rpm.
15. The method of any preceding or following embodiment/feature/aspect, wherein said rotating atomizer disk has a diameter of at least 20 mm.
16. The method of any preceding or following embodiment/feature/aspect, wherein said rotating atomizer disk has a diameter of from about 20 mm to about 200 mm.
17. The method of any preceding or following embodiment/feature/aspect, wherein said rotating atomizer disk has a diameter of from about 35 mm to about 150 mm.
18. The method of any preceding or following embodiment/feature/aspect, wherein said rotating atomizer disk has a diameter of from about 50 mm to about 125 mm.
19. The method of any preceding or following embodiment/feature/aspect, wherein said spray dryer has an inlet temperature of at least 100° C.
20. The method of any preceding or following embodiment/feature/aspect, wherein said spray dryer has an inlet temperature of from about 100° C. to about 200° C.
21. The method of any preceding or following embodiment/feature/aspect, wherein said spray dryer has an inlet temperature of from about 120° C. to about 170° C.
22. The method of any preceding or following embodiment/feature/aspect, wherein said spray dryer has an inlet temperature of from about 130° C. to about 150° C.
23. The method of any preceding or following embodiment/feature/aspect, wherein said spray dryer has an outlet temperature that is lower by at least 10° C. than an inlet temperature.
24. The method of any preceding or following embodiment/feature/aspect, wherein said spray dryer has an outlet temperature that is lower by at least 20° C. than an inlet temperature.
25. The method of any preceding or following embodiment/feature/aspect, wherein said spray dryer has an outlet temperature that is lower by at least 30° C. than an inlet temperature.
26. The method of any preceding or following embodiment/feature/aspect, wherein said spray dryer has an outlet temperature that is lower by at least 50° C. than an inlet temperature.
27. The method of any preceding or following embodiment/feature/aspect, wherein said spray dryer has an outlet temperature that is lower by from about 10° C. to about 100° C. than an inlet temperature.
28. The method of any preceding or following embodiment/feature/aspect, wherein said spray dryer has an outlet temperature that is lower by from about 50° C. to about 100° C. than an inlet temperature.
29. The method of any preceding or following embodiment/feature/aspect, wherein said slurry is fed into said spray dryer at a feed rate of at least 0.5 kg/hour.
30. The method of any preceding or following embodiment/feature/aspect, wherein said slurry is fed into said spray dryer at a feed rate of at least 1 kg/hour.
31. The method of any preceding or following embodiment/feature/aspect, wherein said slurry is fed into said spray dryer at a feed rate of at least 2 kg/hour.
32. The method of any preceding or following embodiment/feature/aspect, wherein said slurry is fed into said spray dryer at a feed rate of from about 0.5 kg/hour to about 5 kg/hour.
33. The method of any preceding or following embodiment/feature/aspect, wherein said slurry is fed into said spray dryer at a feed rate of from about 1 kg/hour to about 4 kg/hour.
34. The method of any preceding or following embodiment/feature/aspect, said method further comprising drying said capacitor grade powder to further reduce moisture content.
35. The method of any preceding or following embodiment/feature/aspect, wherein said drying is at a temperature of at least 50° C. for at least one hour.
36. The method of any preceding or following embodiment/feature/aspect, wherein said drying is at a temperature of at least 70° C. for at least three hours.
37. The method of any preceding or following embodiment/feature/aspect, said method further comprising drying said capacitor grade powder to further reduce moisture content to a moisture content of less than 0.5 wt %, based on weight of said capacitor grade powder.
38. The method of any preceding or following embodiment/feature/aspect, wherein said heat treatment is at a temperature of at least 800° C.
39. The method of any preceding or following embodiment/feature/aspect, wherein said heat treatment is at a temperature of at least 1,000° C.
40. The method of any preceding or following embodiment/feature/aspect, wherein said heat treatment is at a temperature of from about 800° C. to about 1,300° C.
41. The method of any preceding or following embodiment/feature/aspect, wherein said heat treatment is at a temperature of from about 1,000° C. to about 1,300° C.
42. The method of any preceding or following embodiment/feature/aspect, wherein said heat treatment is for at least 10 minutes.
43. The method of any preceding or following embodiment/feature/aspect, wherein said heat treatment is for at least 30 minutes.
44. The method of any preceding or following embodiment/feature/aspect, wherein said heat treatment is for a time of from about 10 minutes to 2 hours.
45. The method of any preceding or following embodiment/feature/aspect, said method further comprising subjecting the capacitor grade powder to at least one deoxidation.
46. The method of any preceding or following embodiment/feature/aspect, wherein said deoxidation comprises subjecting said capacitor grade powder to a temperature of from about 500° C. to 1,000° C. in the presence of at least one oxygen getter.
47. The method of any preceding or following embodiment/feature/aspect, wherein said deoxidation comprises utilizing at least one oxygen getter.
48. The method of any preceding or following embodiment/feature/aspect, wherein said oxygen getter is magnesium metal.
49. The method of any preceding or following embodiment/feature/aspect, wherein said powder in said slurry is phosphorus doped.
50. The method of any preceding or following embodiment/feature/aspect, wherein said powder in said slurry is phosphorus doped to a level of at least 50 ppm.
51. The method of any preceding or following embodiment/feature/aspect, wherein said powder in said slurry is phosphorus doped to a level of at least 100 ppm.
52. The method of any preceding or following embodiment/feature/aspect, wherein said powder in said slurry is phosphorus doped to a level of from about 50 ppm to about 500 ppm.
53. The method of any preceding or following embodiment/feature/aspect, wherein said powder is sodium reduced tantalum powder.
54. The method of any preceding or following embodiment/feature/aspect, wherein said powder is acid washed powder.
55. The method of any preceding or following embodiment/feature/aspect, wherein said powder is acid washed and vacuum dried powder.
56. The method of any preceding or following embodiment/feature/aspect, wherein said powder is sodium reduced tantalum powder that has been acid washed and vacuum dried before forming into said slurry.
57. The method of any preceding or following embodiment/feature/aspect, said method further comprising crushing said powder prior to forming into said slurry.
58. The method of any preceding or following embodiment/feature/aspect, wherein said crushing comprising feeding said powder through a mill.
59. The method of any preceding or following embodiment/feature/aspect, wherein said crushing reduces the particle size to a particle size of from more than 5 microns for a D₅₀ to less than 2.5 microns, as measured by Microtrac.
60. The method of any preceding or following embodiment/feature/aspect, wherein said capacitor grade powder has a Scott density of at least 14 g/in³.
61. The method of any preceding or following embodiment/feature/aspect, wherein said capacitor grade powder has a Scott density of at least 20 g/in³.
62. The method of any preceding or following embodiment/feature/aspect, wherein said capacitor grade powder has a Scott density of at least 25 g/in³.
63. The method of any preceding or following embodiment/feature/aspect, wherein said capacitor grade powder has a Scott density of from about 20 g/in³ to about 405 g/in³.
64. The method of any preceding or following embodiment/feature/aspect, wherein said capacitor grade powder has a Scott density of from about 14 g/in³ to about 40 g/in³.
65. The method of any preceding or following embodiment/feature/aspect, wherein said capacitor grade powder has at least one of the following properties:

a) a Scott Density of from about 14 g/in³ to about 40 g/in³,

b) a D10 particle size of from about 5 microns to about 25 microns,

c) a D50 particle size of from about 20 microns to about 50 microns,

d) a D90 particle size of from about 30 microns to about 100 microns,

e) a BET surface area of from about 0.5 m²/g to about 20 m²/g.

66. The method of any preceding or following embodiment/feature/aspect, wherein said capacitor grade powder has at least one of the following properties:

a) a Scott Density of from about 20 g/in³ to about 37 g/in³,

b) a D10 particle size of from about 12 microns to about 25 microns,

c) a D50 particle size of from about 20 microns to about 40 microns,

d) a D90 particle size of from about 30 microns to about 70 microns,

e) a BET surface area of from about 0.7 m²/g to about 15 m²/g.

67. The method of any preceding or following embodiment/feature/aspect, wherein

said slurry comprises from about 35 wt % to about 70 wt % tantalum powder, based on total weight of said slurry,

said slurry is an aqueous slurry,

said rotating atomizer disk rotates at from about 10,000 rpm to about 50,000 rpm,

said rotating atomizer disk has a diameter of from about 20 mm to about 200 mm,

said spray dryer has an inlet temperature of from about 100° C. to about 200° C.,

said spray dryer has an outlet temperature that is lower by at least 35° C. than an inlet temperature,

said slurry is fed into said spray dryer at a feed rate of at least 0.5 kg/hour, and

said heat treatment is at a temperature of at least 800° C.

68. The method of any preceding or following embodiment/feature/aspect, wherein said rotating atomizer disk rotates at a circumferential speed of at least 25 m/s.
69. The method of any preceding or following embodiment/feature/aspect, wherein said rotating atomizer disk rotates at a circumferential speed of at least 30 m/s.
70. The method of any preceding or following embodiment/feature/aspect, wherein said rotating atomizer disk rotates at a circumferential speed of from about 25 m/s to about 125 m/s.
71. The method of any preceding or following embodiment/feature/aspect, wherein said rotating atomizer disk rotates at a circumferential speed of from about 30 m/s to about 100 m/s.

The present invention can include any combination of these various features or embodiments above and/or below as set forth in sentences and/or paragraphs. Any combination of disclosed features herein is considered part of the present invention and no limitation is intended with respect to combinable features.

The present invention will be further clarified by the following examples, which are intended to be exemplary of the present invention.

### Examples

The following examples were done in accordance with the various options of the present invention and further comparative examples were conducted as well.

For purposes of the present invention, a basic lot tantalum powder that is commercially available from Global Advanced Metals, KK, was used. The details of the basic lot tantalum powder are set forth in Table 1 below. Table 2 below provides the details of the tantalum powder used in Examples 16 and 17.

TABLE 1

| | | Feed material of 150 kCV grade | | | | |
|---|---|---|---|---|---|---|
| | | Exam- | Exam- | Exam- | Exam- | Exam- |
| | | ple 1 | ple 2 | ple 3 | ple 4 | ple 5 |
| | | Raw | Aicomixer | Spartan-1 | Spartan-2 | Atomizer- |
| | condition | — | 20 min | 5400 rpm-5 min | 5400 rpm-5 min | 10000 rpm |
| Physical | BET(m2/g) | 6.32 | 6.00 | 6.10 | 6.00 | 5.99 |
| Analysis | SN(g/inch\hat{ }3) | 9.2 | 10.6 | 10.3 | 9.7 | 11.6 |
| | BD(g/cc) | 0.56 | 0.64 | 0.63 | 0.59 | 0.71 |
| PSD | D10 (um) | 1.885 | 1.348 | 1.113 | 1.147 | 0.909 |
| (microtrac) | D50 (um) | 8.913 | 5.637 | 2.886 | 2.846 | 1.634 |
| | D90 (um) | 24.96 | 19.24 | 9.622 | 9.254 | 4.098 |

TABLE 2

Raw material

| | | Example 16 | Example 17 |
|---|---|---|---|
| | condition | Raw | Raw |
| | CV grade | 120 kCV | 150 kCV |
| Chemical | O (ppm) | 8365 | 10770 |
| Analysis | C (ppm) | 14 | 9 |
| | N (ppm) | 1085 | 1955 |
| | H (ppm) | 1178 | 1135 |
| | Fe (ppm) | 10 | 9 |
| | Ni (ppm) | 14 | 7 |
| | Cr (ppm) | 6 | 4 |
| | Si (ppm) | 10 | 11 |
| | Na (ppm) | 2 | 2 |
| | K (ppm) | 15 | 12 |
| Physical | SN(g/inch\hat{ }3) | 11.9 | 9.3 |
| Analysis | BD(g/cc) | 0.73 | 0.56 |
| PSD | D10 (um) | 1.073 | 1.068 |
| (microtrac) | D50 (um) | 2.666 | 2.361 |
| | D90 (um) | 15.36 | 11.91 |

Example 1, designated as “Raw”, is the basic lot tantalum powder without any pre-processing with regard to pulverizing or granulating or milling. The reference to BET is a reference to BET surface area. SN is the Scott number or Scott density. BD is bulk density. PSD is particle size distribution as measured by Microtrac.

In Table 1, Example 2 is the powder of Example 1 that was then subjected to a Aico mixer for 20 minutes, which is a mixer that was used as a pulverizer. In Example 3, the powder of Example 1 was subjected to a Spartan granulator (Model RMO-4H from Dalton Co., Ltd), which is a granulator that was used as a pulverizer which was operated at 5,400 rpm for 5 minutes. In Example 4, the same Spartan granulator was used as a further test and operated at 5,400 rpm for 5 minutes. In Example 5, the powder of Example 1 was subjected to an atomizer operated at 10,000 rpm once. The atomizer is a mill (Model No. TAP-1WZ-HA from Tokyo Atomizer Mfg Co., Ltd.). The results set forth in Table 1 provide the physical analysis, and particle size distribution after being subjected to one of these pre-processing conditions and, as stated, Example 1 provides the conditions without any pre-processing. For purposes of the present invention, the pre-processing steps of Examples 2-5 are optional with regard to the present application. The atomizer mill had the ability to crush or pulverize the particle more than the Spartan granulator, and the Spartan granulator had the ability to crush or pulverize more than the Aico mixer. In other words, the average particle size was smallest for the atomizer mill and the largest average particle size was from the Aico mixer.

TABLE 3

| | | | | | | | | | | Spartan | Conven- |
|---|---|---|---|---|---|---|---|---|---|---|---|
| | | | | | | | | | | sample | tional |
| | | | | | | | | | | Exam- | Exam- |
| | | Spray dryed samples after Heat Traetment | | | | | | | | ple 14 | ple 15 |
| | | Exam- | Exam- | Exam- | Exam- | Exam- | Exam- | Exam- | Exam- | for | (for |
| | | ple 6 | ple 7 | ple 8 | ple 9 | ple 10 | ple 11 | ple 12 | ple 13 | compar- | compar- |
| | condition | Spartan | Spartan | Atomizer | Atomizer | Raw | Raw | Spartan | Spartan | ison-1) | ison-2) |
| slurry, Ta-Wt % | | 49.1 | 49.1 | 49.2 | 49.2 | 48.6 | 48.6 | 65.3 | 65.3 | — | — |
| disk, rpm | | 17000 | 35000 | 17000 | 35000 | 17000 | 35000 | 17000 | 35000 | — | — |
| φ of disc, mm | | 50 | 50 | 50 | 50 | 50 | 50 | 50 | 50 | — | — |
| circumferential | | 44.5 | 91.6 | 44.5 | 91.6 | 44.5 | 91.6 | 44.5 | 91.6 | — | — |
| speed, m/s | | | | | | | | | | | |
| dryer temp, inlet/ | | 140/90 | 140/90 | 120/73 | 120/73 | 120/70 | 120/70 | 120/82 | 120/82 | — | — |
| outlet, deg. C. | | | | | | | | | | | |
| HT, deg. C. | | 1150 | 1150 | 1150 | 1150 | 1150 | 1150 | 1150 | 1150 | 1150 | 1150 |
| Deox and re-Deox, | | — | — | — | — | — | — | — | — | 750 | 750 |
| deg. C. | | | | | | | | | | | |
| Physical | BET(m2/g) | 3.27 | 3.30 | 3.19 | 3.21 | 3.27 | 3.25 | 3.23 | 3.19 | 3.21 | 3.04 |
| Analysis | SN(g/inch\hat{ }3) | 18.2 | 17.4 | 24.2 | 21.7 | 14.7 | 14.3 | 16.5 | 19.7 | 21.4 | 31.5 |
| | BD(g/cc) | 1.11 | 1.06 | 1.47 | 1.32 | 0.90 | 0.87 | 1.00 | 1.20 | 1.30 | 1.92 |
| PSD | D10 (um) | 23.84 | 18.03 | 21.67 | 15.34 | 5.322 | 17.02 | 2.320 | 17.11 | 10.24 | 25.45 |
| (microtrac) | D50 (um) | 44.67 | 25.49 | 38.09 | 21.83 | 47.87 | 28.28 | 51.54 | 39.95 | 21.86 | 97.62 |
| | D90 (um) | 78.24 | 40.84 | 64.46 | 34.59 | 89.42 | 53.42 | 120.4 | 86.58 | 54.55 | 175.1 |

| | | | | | | | | | |
|---|---|---|---|---|---|---|---|---|---|
| | HT, deg. C. | 1200 | 1200 | 1200 | 1200 | 1200 | 1200 | 1200 | 1200 |
| Physical | O (ppm) | 27940 | 28230 | 27690 | 28560 | 28200 | 28460 | 27560 | 27840 |
| Analysis | BET(m2/g) | 3.00 | 3.03 | 2.92 | 2.91 | 3.01 | 3.00 | 2.96 | 2.93 |
| | SN(g/incn\hat{ }3) | 17.5 | 16.5 | 24.5 | 22.1 | 15.8 | 15.0 | 17.2 | 20.1 |
| | BD(g/cc) | 1.07 | 1.01 | 1.50 | 1.35 | 0.96 | 0.92 | 1.05 | 1.23 |

| | | | | | |
|---|---|---|---|---|---|
| | HT, deg. C. | 1250 | 1250 | 1250 | 1250 |
| Physical | O (ppm) | 27330 | 27320 | 26540 | 27340 |
| Analysis | BET(m2/g) | 2.75 | 2.68 | 2.66 | 2.61 |
| | SN(g/inch\hat{ }3) | 17.6 | 17.1 | 26.3 | 22.9 |
| | BD(g/cc) | 1.07 | 1.04 | 1.60 | 1.40 |

In Examples 6-13, as set forth in Table 3 above, the powder resulting from one of Examples 1-5 was then subjected to the spray drying step of the present invention. Examples 14 and 15 provide comparative data which were powders not subjected to spray drying. Example 14 provides an example of a further agglomeration technique for powder (using a granulator, here, a Spartan granulator) before heat treatment. Example 15 was processed according to conventional powder techniques. Examples 6-13 are after heat treating of the powder. Example 14 is powder agglomerated with a Spartan granulator after heat treatment. Example 15 is a powder made with a conventional process that includes heat treatment to make a porous block and then pulverizing and sieving to form powder and then deoxidation.

More specifically, Table 3 provides the details of the further testing in accordance with the present invention with regard to Examples 6-13. In Table 3, the slurry is a reference to the water slurry that contains the tantalum powder from one of Examples 1-5. Ta-Wt. % is a reference to the percentage by weight of tantalum present in the aqueous slurry. In addition, the atomizer disk rpm is set forth as “disk, rpm” and the dryer temperature (inlet and outlet in deg. C.) is provided. HT is a reference to the heat treatment that was done at that particular temperature for 30 minutes. Table 3 also provides physical analysis using the same nomenclature as in Table 1. In addition, for Examples 6-13, additional samples were subjected to a different heat treatment temperature, namely 1,200° C., for 30 minutes. Further, as an additional example, further lots of Examples 6-9 were separately subjected to a heat treatment at 1,250° C. for 30 minutes to see the effects of higher heat treatment temperatures.

In more detail, Examples 6 and 7 started with the powder from Example 3. Examples 8 and 9 started with the powder from Example 5. Examples 10 and 11 started with the powder from Example 1. Examples 12 and 13 started with the powder of Example 4.

As can be seen from the data, when a rpm of the atomizer disk is significantly increased, the particle size distribution can be altered and, in fact, the overall particle size distribution can be reduced or tightened, and this is comparing Example 6 with Example 7, and comparing Example 8 with Example 9, and comparing Example 10 with Example 11, and comparing Example 12 with Example 13.

In comparing Examples 6-13 to the comparative Example 14 and comparative Example 15, it is noted that particle size distribution with regards to sharpness of the peak and the peak position for Examples 6 to 13 are narrower than Example 14 and Example 15.

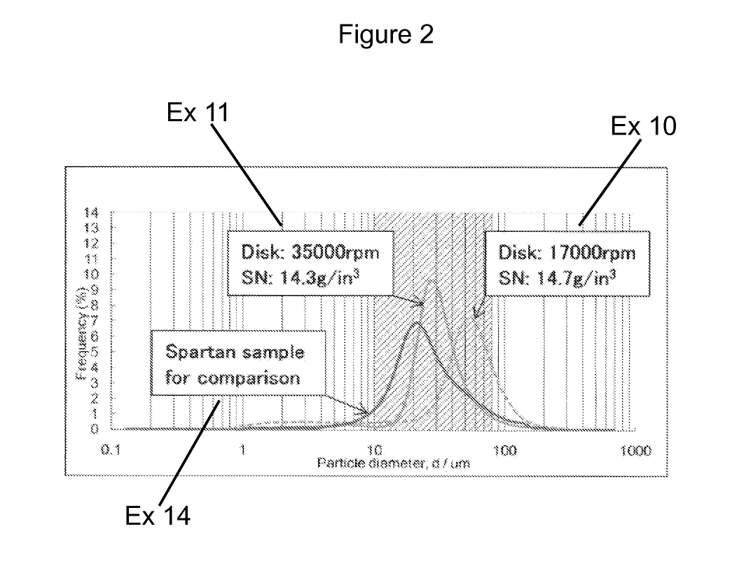

More specifically, FIG. 2 provides a graph of the particle diameter distribution (PSD) versus frequency in % (by number of particles) for Examples 10, 11, and 14 (after a heat treatment (HT) of 1200 deg C.). As can be seen, when disk rotation used in the spray dryer is increased, the PSD shifted and also provided for a sharper and higher peak (more narrow) peak representing a tighter PSD. Also, as a result of the atomizer speed, the Scott number or density can be altered. Example 14 (comparative) shows a much broader PSD and a lower peak, which is considered less desirable for anode production.

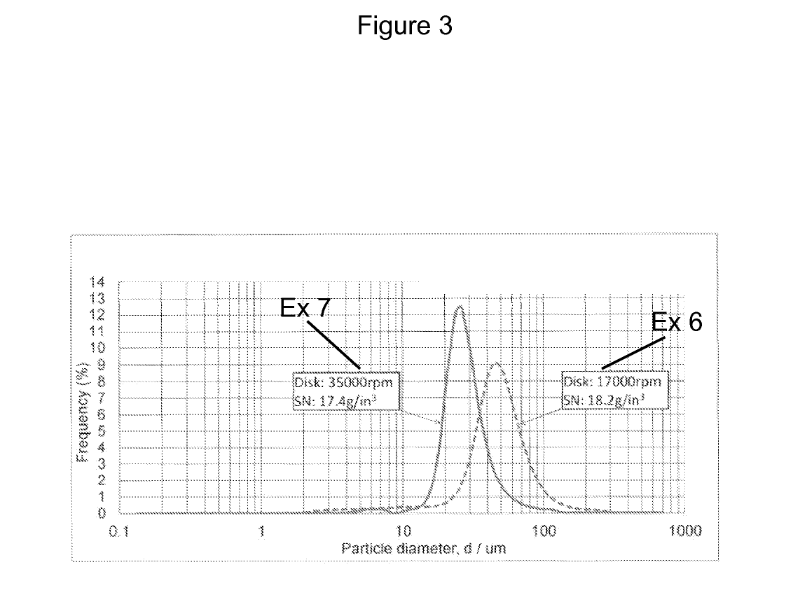

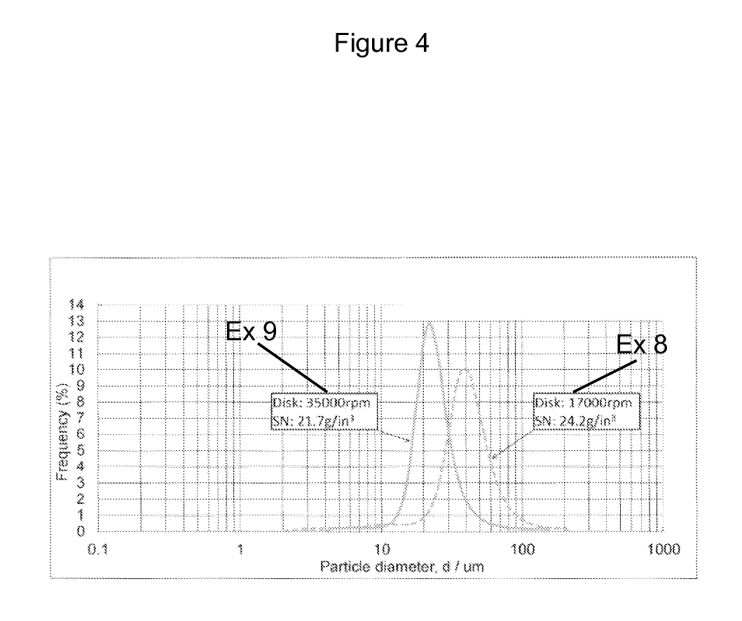

FIG. 3 provides a graph of the particle diameter distribution (PSD) versus frequency in % (by number of particles) for Examples 6 and 7 (after a heat treatment (HT) of 1200 deg C.). As can be seen again, the atomizer speed for the spray dryer had an impact on the PSD with grades to location and height of peak, and tightness of peak. It is further noted that similar results were obtained and shown in FIG. 4 for Examples 8 and 9 (after a heat treatment (HT) of 1200 deg C.). It is worth noting that by crushing the particles, the Scott number or density was increased in the heated treated powder, and depending on the crushing device/method, the sharpness, peak height, and location of the peak can be altered. All of this provides the user the ability to further control the PSD and to ‘dial in’ this parameter to end user needs. As can be further seen in Table 3 above, the PSD when using the optional crushing step prior to forming the slurry, the PSD was much narrower or tighter which is especially noticeable in viewing the D10 and D90 for each of the results in Table 3 and can be further appreciated in FIGS. 2-4.

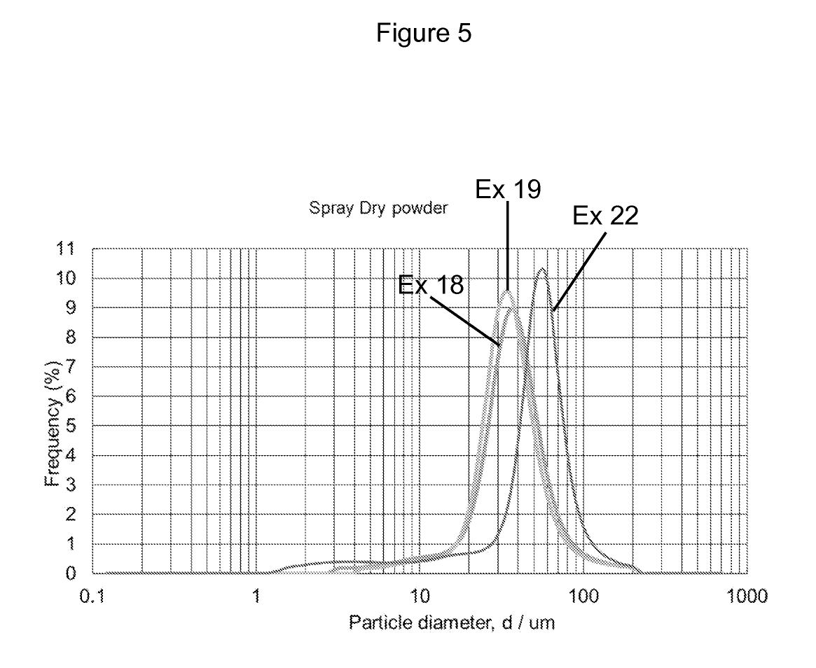

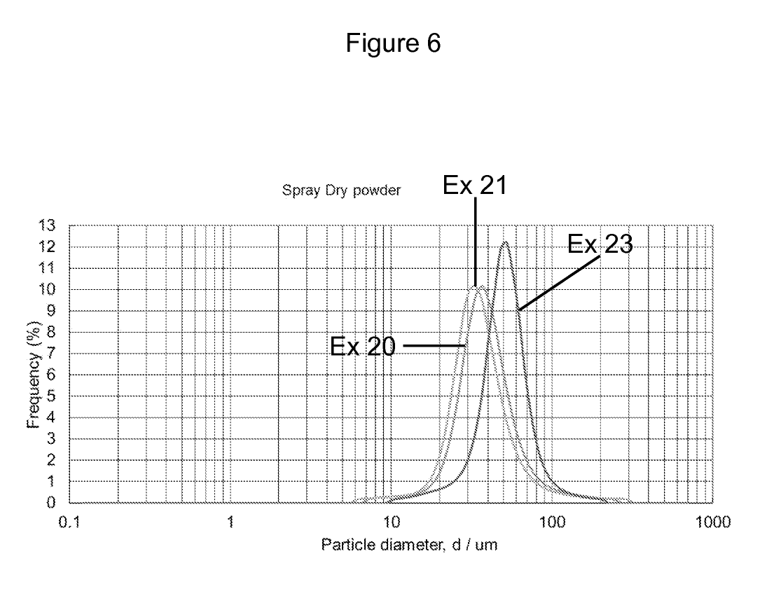

Table 4 below sets forth additional examples of the present application. Specifically, Examples 18-21 are examples of the present application while Examples 22 and 23 are for comparative purposes. The same nomenclature set forth in Table 3 above is used in Table 4. In Examples 18 and 19, the powder described in Example 16 was used. In Examples 20 and 21, the powder described in Example 17 was used. In Example 22, a tantalum powder was used but was not subjected to spray drying only agglomeration using a Spartan granulator. Similarly, Example 23 used a tantalum powder but with no spray drying but only agglomeration using a Spartan granulator. In Examples 18-21, the powders were subjected to a Spartan granulator as in the above example which was operated at 5,400 rpm either for 10 minutes or 20 minutes as specified in Table 4. The powder of Examples 18-21 were then subjected to a spray drying step of the present invention with the operating parameter set forth in Table 4. As can be seen in Table 4, by varying the Spartan operation time which created different particle sizes, the Scott density or Scott number as well as bulk density can be altered in the process of the present invention to achieve desirable Scott numbers or Scott densities. This can be achieved in combination with desirable particle size distributions as shown by the D10, D50, and D90 ranges which are significantly tighter with regard to particle size distribution then Examples 22 and 23 where the particle size distribution was quite larger. Thus, as shown in Table 4, with the present invention, desirable Scott numbers or densities can be achieved in combination with desirable particle size distributions which are quite narrow or tight. These results with regard to particle diameter versus frequency (percent by number of particles) for Examples 18, 19, 22 and Examples 20-23 are set forth in FIGS. 5 and 6.

TABLE 4

| | | | | | | Spartan | Spartan |
|---|---|---|---|---|---|---|---|
| | | | | | | sample | sample |
| | | | | | | Exam- | Exam- |
| | | Spray dryed samples(after re-DX) | | | | ple 22 | ple 23 |
| | | Exam- | Exam- | Exam- | Exam- | (for | (for |
| | | ple 18 | ple 19 | ple 20 | ple 21 | compar- | compar- |
| | condition | Spartan-10 min* | Spartan-20 min | Spartan-10 min | Spartan-20 min | ison-3) | ison-4) |
| | CV grade | 120 kCV | 120 kCV | 150 kCV | 150 kCV | 120 kCV | 150 kCV |
| slurry, Ta-Wt % | | 55.0 | 55.0 | 55.0 | 55.0 | — | — |
| disk, rpm | | 16000 | 16000 | 16000 | 16000 | — | — |
| φ of disc, mm | | 110 | 110 | 110 | 110 | — | — |
| circumferential | | 92.1 | 92.1 | 92.1 | 92.1 | — | — |
| speed, m/s | | | | | | | |
| dryer temp, inlet/ | | 140/82 | 140/86 | 140/86 | 140/86 | — | — |
| outlet, deg. C. | | | | | | | |
| HT, deg. C. | | 1150 | 1150 | 1150 | 1150 | 1150 | 1150 |
| Deox and re-Deox, | | 750 | 750 | 750 | 750 | 750 | 750 |
| deg. C. | | | | | | | |
| Chemical | O (ppm) | 5430 | 5460 | 5610 | 5490 | 5190 | 6850 |
| Analysis | C (ppm) | 181 | 186 | 186 | 182 | 14 | 23 |
| | N (ppm) | 3140 | 3520 | 4960 | 5190 | 1900 | 2300 |
| | H (ppm) | 128 | 155 | 168 | 181 | 154 | 237 |
| | Fe (ppm) | 16 | 18 | 13 | 14 | 13 | 9 |
| | Ni (ppm) | 10 | 8 | <5 | 5 | 8 | 10 |
| | Cr (ppm) | <5 | 7 | 7 | <5 | <5 | <5 |
| | Si (ppm) | 3 | 2 | 2 | 2 | <2 | 4 |
| | Na (ppm) | 1 | 1 | 1 | 1 | 2 | 1 |
| | K (ppm) | 8 | 7 | 5 | 5 | 10 | 7 |
| | Mg (ppm) | 18 | 25 | 10 | 12 | 8 | 22 |
| | P (ppm) | 127 | 131 | 128 | 132 | 132 | 149 |
| Physical | BET(m2/g) | 2.58 | 2.61 | 2.65 | 2.63 | 2.25 | 3.07 |
| Physical | SN(g/inch\hat{ }3) | 26.5 | 30.5 | 28.5 | 32.4 | 28.3 | 33.1 |
| Analysis | BD(g/cc) | 1.61 | 1.86 | 1.74 | 1.98 | 1.73 | 2.02 |
| PSD | D10 (um) | 18.11 | 19.60 | 22.84 | 21.06 | 13.48 | 30.86 |
| (microtrac) | D50 (um) | 35.10 | 33.19 | 36.16 | 32.82 | 50.78 | 48.49 |
| | D90 (um) | 61.98 | 58.32 | 63.03 | 58.59 | 80.44 | 72.8 |

*Spartan condition of chopper rpm was fixed 5400 rpm.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A method of making a capacitor grade powder comprising
feeding a slurry of powder into a spray dryer that includes a rotating atomizer disk and forming dried agglomerated powder, and
heat treating said dried agglomerated powder to form said capacitor grade powder, wherein said powder is tantalum, niobium, or a niobium suboxide.

2. The method of claim 1, wherein said powder is tantalum metal powder.

3-6. (canceled)

7. The method of claim 1, wherein said slurry is an aqueous slurry.

8-22. (canceled)

23. The method of claim 1, wherein said spray dryer has an outlet temperature that is lower by at least 10° C. than an inlet temperature.

24-27. (canceled)

28. The method of claim 1, wherein said spray dryer has an outlet temperature that is lower by from about 50° C. to about 100° C. than an inlet temperature.

29. The method of claim 1, wherein said slurry is fed into said spray dryer at a feed rate of at least 0.5 kg/hour.

30-31. (canceled)

32. The method of claim 1, wherein said slurry is fed into said spray dryer at a feed rate of from about 0.5 kg/hour to about 5 kg/hour.

33. (canceled)

34. The method of claim 1, said method further comprising drying said capacitor grade powder to further reduce moisture content.

35. The method of claim 34, wherein said drying is at a temperature of at least 50° C. for at least one hour.

36. (canceled)

37. The method of claim 1, said method further comprising drying said capacitor grade powder to further reduce moisture content to a moisture content of less than 0.5 wt %, based on weight of said capacitor grade powder.

38. The method of claim 1, wherein said heat treatment is at a temperature of at least 800° C.

39. (canceled)

40. The method of claim 1, wherein said heat treatment is at a temperature of from about 800° C. to about 1,300° C.

41-43. (canceled)

44. The method of claim 1, wherein said heat treatment is for a time of from about 10 minutes to 2 hours.

45. The method of claim 1, said method further comprising subjecting the capacitor grade powder to at least one deoxidation.

46. The method of claim 45, wherein said deoxidation comprises subjecting said capacitor grade powder to a temperature of from about 500° C. to 1,000° C. in the presence of at least one oxygen getter.

47. The method of claim 45, wherein said deoxidation comprises utilizing at least one oxygen getter.

48-49. (canceled)

50. The method of claim 1, wherein said powder in said slurry is phosphorus doped to a level of at least 50 ppm.

51-52. (canceled)

53. The method of claim 1, wherein said powder is sodium reduced tantalum powder.

54-55. (canceled)

56. The method of claim 1, wherein said powder is sodium reduced tantalum powder that has been acid washed and vacuum dried before forming into said slurry.

57. The method of claim 1, said method further comprising crushing said powder prior to forming into said slurry.

58. (canceled)

59. The method of claim 57, wherein said crushing reduces the particle size to a particle size of from more than 5 microns for a D₅₀ to less than 2.5 microns, as measured by Microtrac.

60-64. (canceled)

65. The method of claim 1, wherein said capacitor grade powder has at least one of the following properties:
a) a Scott Density of from about 14 g/in³ to about 40 g/in³,
b) a D10 particle size of from about 5 microns to about 25 microns,
c) a D50 particle size of from about 20 microns to about 50 microns,
d) a D90 particle size of from about 30 microns to about 100 microns,
e) a BET surface area of from about 0.5 m²/g to about 20 m²/g.

66. The method of claim 1, wherein said capacitor grade powder has at least one of the following properties:
a) a Scott Density of from about 20 g/in³ to about 37 g/in³,
b) a D10 particle size of from about 12 microns to about 25 microns,
c) a D50 particle size of from about 20 microns to about 40 microns,
d) a D90 particle size of from about 30 microns to about 70 microns,
e) a BET surface area of from about 0.7 m²/g to about 15 m²/g.

67. The method of claim 1, wherein
said slurry comprises from about 35 wt % to about 70 wt % tantalum powder, based on total weight of said slurry,
said slurry is an aqueous slurry,
said rotating atomizer disk rotates at from about 10,000 rpm to about 50,000 rpm,
said rotating atomizer disk has a diameter of from about 20 mm to about 200 mm,
said spray dryer has an inlet temperature of from about 100° C. to about 200° C.,
said spray dryer has an outlet temperature that is lower by at least 35° C. than an inlet temperature,
said slurry is fed into said spray dryer at a feed rate of at least 0.5 kg/hour, and
said heat treatment is at a temperature of at least 800° C.

68. The method of claim 1, wherein said rotating atomizer disk rotates at a circumferential speed of at least 25 m/s.

69. (canceled)

70. The method of claim 1, wherein said rotating atomizer disk rotates at a circumferential speed of from about 25 m/s to about 125 m/s.

71. (canceled)
